(19) United States
(12) Patent Application Publication
(10) Pub. No.: US 2006/0023909 A1
(43) Pub. Date: Feb. 2, 2006

(54) Sound-tube and method of shaping a sound tube for a hearing aid

(75) Inventor: Esfandiar Grafenberg, Effeltrich (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: Siemens Audiologische Technik GmbH

(21) Appl. No.: 11/192,654

(22) Filed: Jul. 29, 2005

(30) Foreign Application Priority Data
Jul. 30, 2004 (DE) 10 2004 037 070.2

(51) Int. Cl. H04R 25/00

(52) U.S. Cl. 381/330

(57) ABSTRACT

The aim is for an individually shaped sound tube for connecting to a hearing aid that can be worn behind the ear to be produced by simple means. The sound tube includes a sleeve made of a plastic material surrounding a plastically ductile metal wire. When the sound tube has been individually shaped, the plastic material is treated in such a way that, post treatment, it will retain its defined shape in an elastically ductile manner. The metal wire is then removed from the sound tube.

### CROSS REFERENCE TO RELATED APPLICATIONS

This application claims priority to the German application No. 10 2004 037 070.2, filed Jul. 30, 2004 which is incorporated by reference herein in its entirety.

### FIELD OF INVENTION

The invention relates to a method for shaping a sound tube for conducting sound between a hearing aid that can be worn behind the ear and a hearing-aid wearer's auditory canal as well as to a sound tube of said type and to the use of a sound tube of said type in connection with a hearing aid that can be worn behind the ear.

### BACKGROUND OF INVENTION

In a hearing aid that can be worn behind the ear the sound produced by the hearing aid is as a rule transmitted from the hearing aid to a hearing-aid wearer's eardrum via a sound tube. Said tube is secured into position at one end of the hearing aid and terminates at its other end typically in an otoplasty part completely or partially sealing the hearing-aid wearer's auditory canal. If the sound tube terminates slackly in the auditory canal, which is to say without being retained by an otoplasty part, then the term “open feed” is used.

### SUMMARY OF INVENTION

The sound tube is usually flexible in terms of the shape it can assume and will not maintain a particular shape once the hearing aid has been detached. Pre-shaped, elastically ductile sound tubes are, however, also known. The problem arises therewith that an acoustics technician specializing in hearing aids has to maintain a selection of sound tubes of such type of different shape and length so as to have a sound tube in stock that will at least partly suit the majority of hearing-aid wearers. Particularly when a sound tube is used that also has to perform a support function a relatively stable shape matched to the contours of the base of the external ear and those of the tragus is essential for ensuring that the hearing aid that can be worn behind the ear will be securely seated and the ear-fitting piece will not be under tension when positioned in the auditory canal.

A support hook for a hearing aid that can be worn behind the ear which hook is made of a plastic material and has a durable metal core running through it is known from DE 298 19 415 U1. Said support hook can hence be universally accommodated to the shape of the hearing-aid wearer's ear without heat treatment.

A hearing aid that can be worn behind the ear and has a retention part is known from DE 100 48 337 C1. Said retention part is elastic in its normal state and plastically ductile in its heated state.

An object of the present invention is to provide for an individually fitting sound tube for the wearer of a hearing aid, which can be manufactured in a short period of time.

Said object is achieved by means of a method for shaping a sound tube for conducting sound between a hearing aid that can be worn behind the ear and a hearing-aid wearer's auditory canal, with said sound tube being made of a plastic material and initially having a metal core running at least partway through it comprising the following steps:

individual shaping of the initially plastically ductile sound tube to accommodate it to the hearing-aid wearer,

treating the plastic material in such a way that the sound tube will retain its individual shape in an elastically ductile manner,

Removing the metal core from the sound tube.

Said object is further achieved by means of a sound tube for conducting sound between a hearing aid that can be worn behind the ear and a hearing-aid wearer's auditory canal, with said sound tube being embodied at least in a partial section from a plastic material surrounding a metal core, with said sound tube being plastically ductile owing to the metal core, with said plastic material being treatable in such a way that, post treatment, it will retain its given individual shape in an elastically ductile manner, and with said metal core being able to be removed from the sound tube after the plastic material has been individually shaped and treated.

Said object is further achieved by providing a hearing aid having a sound tube configured according to the inventive concept.

For individual shaping, a plastically ductile metal core, embodied preferably as pliable wire, is initially run through the sound tube. The plastic material itself can be plastically or elastically ductile prior to being treated, with its given shape being determined by the metal core. The sound tube can thereby easily be given an individual shape accommodated to a hearing-aid wearer's individual anatomy. The plastic material is then treated in such a way that, post treatment, it will retain its given individual shape in an elastically ductile manner. The metal core can then be withdrawn from the sound tube which, consisting thereafter only of the plastic sleeve, will retain its given shape without the application of an external force. The hearing aid along with the sound tube and, where applicable, the ear-fitting piece, will as a result be easy to attach to and detach from the ear without the risk of permanently altering the given individual shape of the sound tube when it is attached or detached.

The advantage offered by the invention is that an acoustics technician specializing in hearing aids will only need to stock a sound tube according to the invention, which tube can then be accommodated to any anatomy of the ear. Owing to the certain degree of rigidity and elastic ductility displayed by the finished sound tube it can also be given a support function. The support hook customarily hitherto employed in hearing aids that can be worn behind the ear can consequently be dispensed with. By removing the metal core after shaping has been carried out, a sound tube made as a rule of a transparent plastic material will also remain very inconspicuous.

So that the sound tube will maintain its shape in an elastically ductile manner when the metal core has been removed, said sound tube is treated prior to removal of the metal core in such a way that the plastic material of the sound tube will retain its defined shape in an elastically ductile manner. This treatment preferably takes the form of applying heat energy. The sound tube can for this purpose be heated externally. Another possibility is to heat the metal core and thus apply the heat energy, as it were, internally. A further advantageous method of treatment is to apply energy through irradiation with UV light. Suitable irradiation devices for this are available at an economic cost. Treating the sound tube to produce a defined, elastic, ductile shape is not limited to the cited methods. Rather it is the case that numerous other methods can be applied.

### BRIEF DESCRIPTION OF THE DRAWINGS

The invention is explained in more detail below with the aid of an exemplary embodiment.

FIG. 1 shows a sound tube according to the invention in the as supplied condition,

FIG. 2 shows a sound tube shaped in keeping with a hearing-aid wearer's individual anatomic features,

FIG. 3 shows the cutting-to-length of the sound tube according to FIG. 2,

FIG. 4 shows a heat treatment of the individually shaped sound tube, and

FIG. 5 shows the withdrawing of a metal wire from the individually shaped sound tube.

### DETAILED DESCRIPTION OF INVENTION

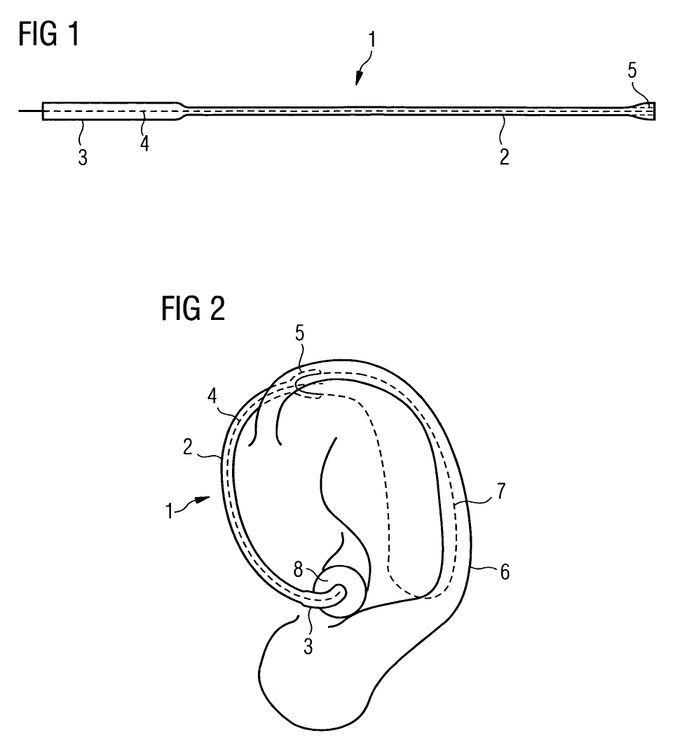

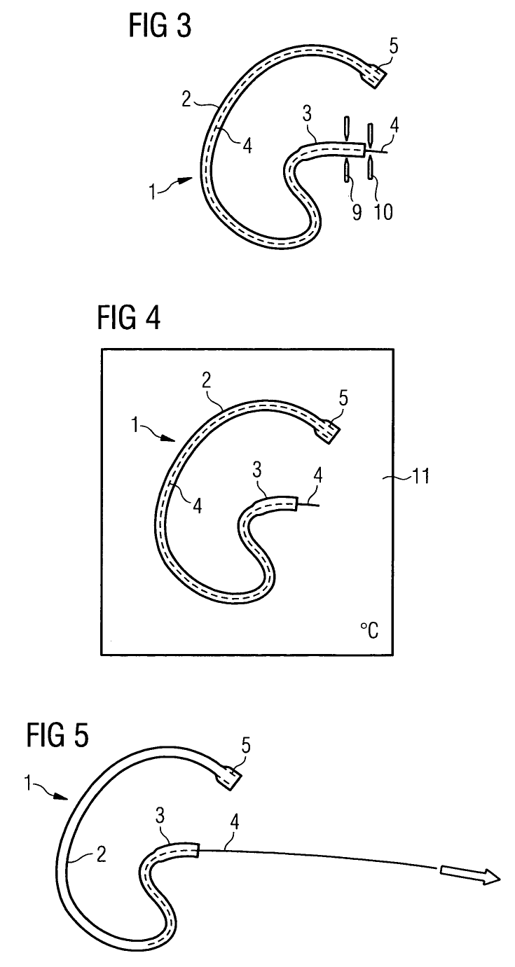

FIG. 1 shows by way of example a sound tube 1 according to the invention in an as-supplied condition. The sound tube 1 extends in a straight line in this condition. The sound tube 1 includes a sleeve 2 made of a plastic material. Said sleeve terminates at one end in a connector 5 for connecting to a hearing aid. The sound tube 1 is splayed at the other end in an area 3, with said area 3 being in the case of a hearing aid that is being worn as a rule inserted into an ear-fitting piece in the form of an individually shaped otoplasty part or a universally fitting olive.

FIG. 2 shows a hearing aid 7 that can be worn behind an ear 6 having a sound tube 1 connecting the hearing aid 7 to an ear-fitting piece 8 projecting into the auditory canal. A plastically ductile metal wire 4 has been run through the sound tube 1 so that the sound tube 1 can be accommodated in terms of its given external shape to the hearing-aid wearer's individual anatomic features. When the sound tube has been thus accommodated, the hearing aid 7 and the sound tube 1 are carefully detached from the ear 6 then separated from each other so that the given individual shape of the sound tube 1 will remain unchanged. In an ensuing treatment step the sound tube 1 in the splayed area 3 and the metal wire 4 are shortened to the requisite length by means of the cutting tools 9 and 10. The sound tube 1 is then subjected to heat treatment in a heating chamber 11, as is illustrated in FIG. 4. Being no longer required following the plastic material's heat treatment, the metal wire 4 can then be withdrawn from the sound tube 1. This is illustrated in FIG. 5. As a result of the heat treatment the plastic sleeve 2 now forming the sound tube will retain its defined shape. It will be elastically ductile after the heat treatment so, while consequently being easy to change from its defined shape for the purpose of securing the hearing aid 7 into position behind the ear 6 and of detaching the hearing aid, it will then nonetheless repeatedly return automatically to its once defined shape. The plastic sleeve 2 forming the sound tube 1 is preferably made of a transparent material so that the now finished, individually shaped sound tube 1 will scarcely be noticeable to third persons while being worn on the ear.

The above-cited steps for producing an individually shaped sound tube do not necessarily have to be performed in the cited sequence. For example, a sound tube present in the as-supplied condition can be initially shortened as early as at the start of the accommodating process if the requisite length is already discernible from the individual ear to which the sound tube is to be accommodated. Cutting-to-length (shortening) and shaping can furthermore also be performed repeatedly until the length and shape provide an optimal fit. It is, moreover, also possible for cutting-to-length not to take place until heat treatment has been applied so that the given individual shape will not be inadvertently altered during this process.

An individually accommodated sound tube can be produced in a short time thanks to the invention. In contrast to when pre-shaped tubes are used, the acoustics technician will only need to stock this single type of sound tube when a sound tube according to the invention is used. Said tube can then be individually accommodated to any ear anatomy, a factor that will enhance the acoustics technician's flexibility and result in greater comfort for the hearing-aid wearer.

1.-9. (canceled)

10. A method of shaping a sound tube for conducting sound from a hearing aid configured to be worn behind an ear to an auditory canal of a hearing aid user, the sound tube made of a plastic material, initially having a metal core running at least partially through the sound tube, and initially being plastically ductile, the method comprising the following steps:
shaping the sound tube for individually accommodating the sound to the hearing aid user;
treating the plastic material such that the sound tube retains its shape while being elastically ductile; and
removing the metal core from the sound tube.

11. The method according to claim 10, wherein treating the plastic material includes heating the plastic material.

12. The method according to claim 11, wherein the plastic material is heated indirectly by heating the core.

13. The method according to claim 10, wherein treating the plastic material includes irradiating the plastic material.

14. The method according to claim 13, wherein the plastic material is irradiated by ultraviolet light.

15. A sound tube for conducting sound from a hearing aid configured to be worn behind an ear to an auditory canal of a hearing aid user, the sound tube comprising:
a plastic material at least partially forming the sound tube; and
a metal core embedded in the plastic material for plastically shaping the sound tube according to a desired shape, wherein the plastic material is adapted to be treated such that after treatment, the plastic material will retain the desired shape while being elastically ductile, and
the metal core is adapted to be removed from the plastic material after treatment of the plastic material.

16. The sound tube according to claim 15, wherein the plastic material is adapted to be treated by heating the plastic material to obtain the desired shape.

17. The sound tube according to claim 15, wherein the plastic material is adapted to be treated by irradiating the plastic material by ultraviolet light to obtain the desired shape.

18. A hearing aid, comprising a sound tube for conducting sound from the hearing aid to an auditory canal of a hearing aid user, the sound tube comprising:
a plastic material at least partially forming the sound tube; and
a metal core embedded in the plastic material for plastically shaping the sound tube according to a desired shape, wherein
the plastic material is adapted to be treated such that after treatment, the plastic material will retain the desired shape while being elastically ductile, and
the metal core is adapted to be removed from the plastic material after treatment of the plastic material.
